(19) United States
(12) Patent Application Publication
(10) Pub. No.: US 2006/0254797 A1
(43) Pub. Date: Nov. 16, 2006

(54) ELECTRICAL CONDUCTOR ASSEMBLY

(75) Inventors: Ali A. Charara, Dearborn Heights, MI (US); Armando A. Biol, Bohol (PH)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/908,485

(22) Filed: May 13, 2005

(51) Int. Cl. H02G 3/04

(52) U.S. Cl. 174/72 A

(57) ABSTRACT

An electrical conductor assembly for use with a vehicle having a moveable part includes a guide member that is mountable on the moveable part, and a carrier that is moveable along the guide member between first and second carrier positions as the moveable part moves between first and second part positions. The assembly further includes an extendable conductor associated with the carrier and being moveable between a retracted position and an extended position as the carrier moves between the first and second carrier positions.

### BACKGROUND OF THE INVENTION

1. Field of the Invention

The invention relates to an electrical conductor assembly for use with a moveable part of a vehicle.

2. Background Art

A prior wire harness assembly for use with a sliding vehicle door includes a housing mounted on the door, a flexible metal chain track disposed in the housing, and a slider attached to an end of the chain track and being slideable along an edge of the housing. The assembly further includes a swing member pivotally attached to the slider and vehicle body. A wire harness extends through the chain track, the slider and the swing member, and includes a electrical connector at each end. When the door is moved between open and closed positions, the slider moves with respect to the housing, which causes the chain track and wire harness to bend at different locations.

### SUMMARY OF THE INVENTION

Under the invention, an electrical conductor assembly for use with a vehicle having a moveable part is provided. In one embodiment, the assembly includes a guide member that is mountable on the moveable part, and a carrier that is moveable along the guide member between first and second carrier positions as the moveable part moves between first and second part positions. The assembly further includes an extendable conductor associated with the carrier and being moveable between a retracted position and an extended position as the carrier moves between the first and second carrier positions.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic side view of a vehicle having a sliding door with an electrical conductor assembly according to the invention mounted on the door, wherein the door is shown in a closed position;

FIG. 2 is a schematic top view of the vehicle shown in FIG. 1, wherein the door is shown in the closed position in solid lines, and an open position in phantom lines;

FIG. 3 is a perspective view of the wire harness assembly, which includes an extendable conductor connected to a carrier that is moveable along a guide member, wherein the carrier is shown in a first carrier position proximate an end of the guide member, and the conductor is shown in a retracted position;

FIG. 4 is a perspective view of the wire harness assembly showing the carrier in a second carrier position proximate an opposite end of the guide member, and showing the conductor in an extended position;

FIG. 5 is a fragmentary perspective view of the wire harness assembly showing the carrier engaged with a groove formed in the guide member, wherein the conductor has been omitted;

FIG. 6 is an exploded perspective view of the carrier;

FIG. 7 is a cross-sectional view of the conductor; and

FIG. 8 is a cross-sectional view of a second embodiment of an electrical conductor assembly according to the invention.

### DETAILED DESCRIPTION OF THE PREFERRED EMBODIMENT(S)

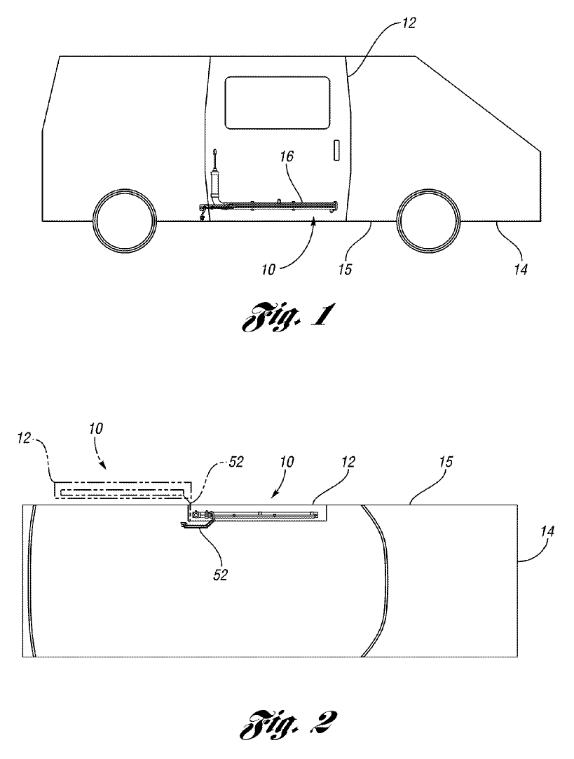

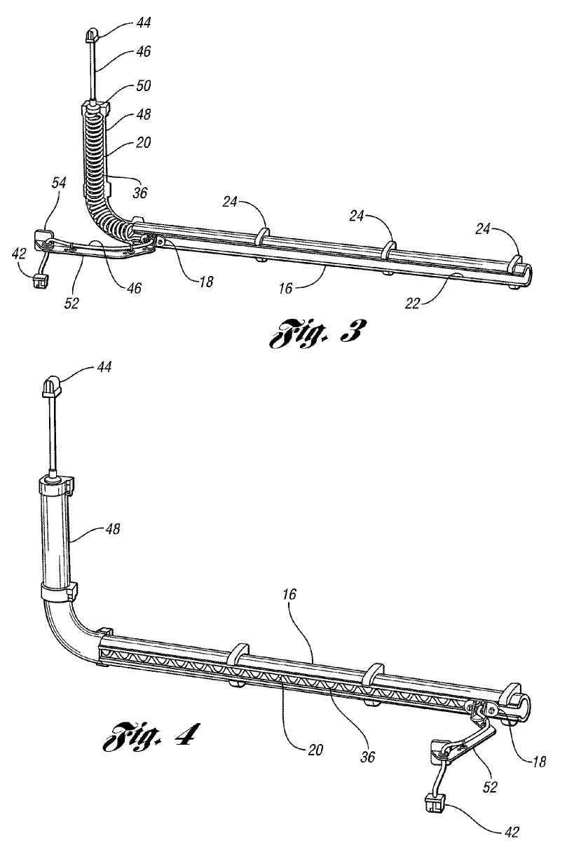

FIG. 1 shows an electrical conductor assembly, such as a wire harness assembly 10, according to the invention mounted on a movable part, such as sliding door 12, of a motor vehicle 14. Referring to FIGS. 1 and 2, the door 12 is movable longitudinally with respect to vehicle body 15 between a first position, such as a closed position shown in FIG. 1, and a second position, such as an open position shown in phantom lines in FIG. 2.

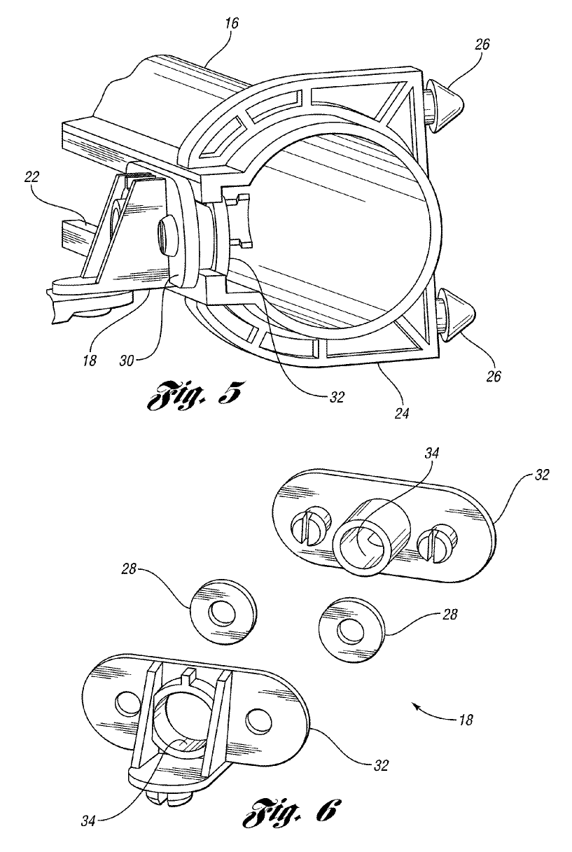

Referring to FIGS. 1 and 3, the assembly 10 includes a guide member 16 mounted on the door 12, a carrier 18 that is movable along the guide member 16, and an extendable conductor 20 associated with the carrier 18. The carrier 18 is movable between a first carrier position, shown in FIG. 3, and a second carrier position, shown in FIG. 4, when the door 12 is moved between the closed position and the open position. The conductor 20 is movable between a retracted position, shown in FIG. 3, and an extended position, shown in FIG. 4, as the carrier 18 moves between the first carrier position and the second carrier position.

While the guide member 16 may have any suitable configuration for guiding movement of the carrier 18, in one embodiment the guide member 16 comprises a generally straight tubular member having a longitudinal groove 22. Referring to FIG. 4, the guide member 16 may also function as a housing member that receives a portion of the conductor 20 when the conductor 20 is in the extended position.

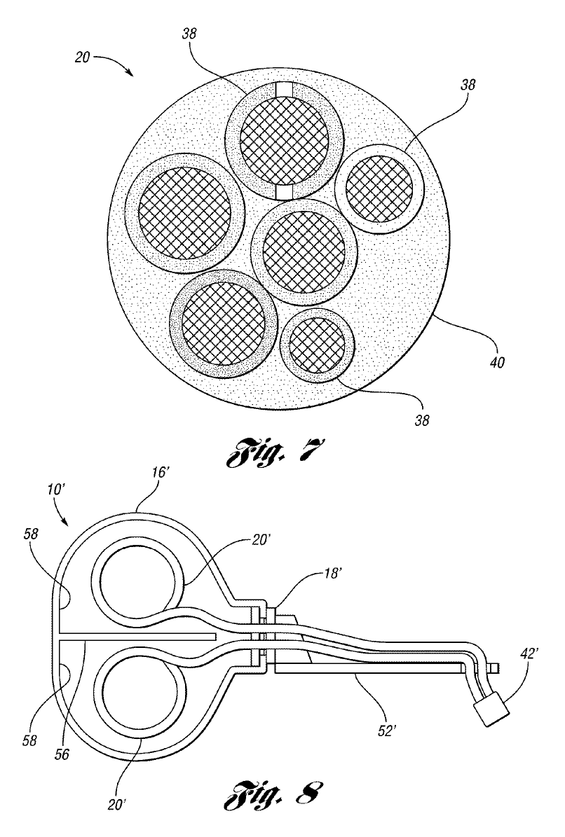

Furthermore, the guide member 16 may be mounted on the door 12 in any suitable manner. For example, the guide member 16 may be connected to the door 12 using fastener members 24. Referring to FIG. 5, each fastener member 24 may have one or more projections 26 that snap-fit into corresponding apertures in the door 12. As another example, the guide member 16 may be attached to the door 12 with any suitable fasteners, such as bolts and/or screws.

The carrier 18 may also have any suitable configuration such that the carrier 18 is movable along the guide member 16. Referring to FIGS. 5 and 6 for example, the carrier 18 may comprise a roller mechanism having one or more rollers 28 that are movable along the groove 22 of the guide member 16. The carrier 18 may also include first and second flange members 30 and 32, respectively, disposed on opposite sides of the rollers 28. In the embodiment shown in FIG. 6, each flange member 30 and 32 has an aperture 34 for receiving the conductor 20.

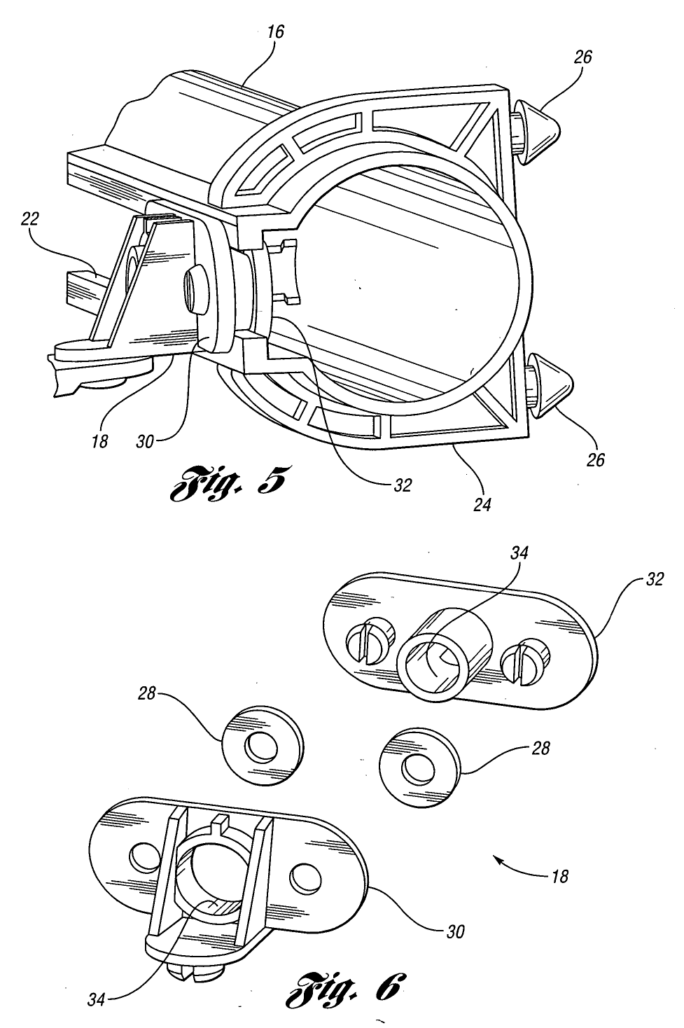

The conductor 20 may have any suitable configuration for conducting electricity and for enabling the conductor 20 to move between the extended and retracted positions. In the embodiment shown in the FIGS. 3 and 4, for example, the conductor 20 includes a main body 36 having a coiled configuration. Furthermore, the conductor 20 may comprise a cable including one or more wires or other electrical conductors that are insulated from each other. Referring to FIG. 7, for example, the conductor 20 may include multiple insulated wires 38 that are surrounded by an insulating jacket 40.

Returning to FIGS. 3 and 4, the conductor 20 may also include first and second electrical connectors 42 and 44, respectively, attached to opposite ends of the main body 36, such as with uncoiled conductor portions 46. The electrical connectors 42 and 44 may be used to connect the assembly 10 to other electrical components. For example, the first electrical connector 42 may be connected to a vehicle body wire harness of the vehicle 14, and the second electrical connector 44 may be connected to a door wire harness located in the door 12.

The assembly 10 may also include a housing 48 attached to the guide member 16 for housing a portion of the conductor 20, such as the main body 36 of the conductor 20, when the conductor 20 is in the retracted position. The housing 48 is shown in section in FIG. 3 to reveal the main body 36 of the conductor 20. A connector member, such as an edge protector 50, is also shown for connecting the conductor 20 to the housing 48.

The housing 48 may have any suitable shape to permit expansion and retraction of the conductor 20. For example, the housing 48 may be a generally straight member that is generally coaxially aligned with the guide member 16, or the housing 48 may extend at an angle with respect to the guide member 16 as shown in FIGS. 3 and 4.

In addition, the assembly 10 may include a link member 52 pivotally connected to the carrier 18 and the vehicle body 15, such as with a hinge 54. As shown in FIG. 3, the link member 52 may be attached to and support a portion of the conductor 20 extending between the guide member 16 and the vehicle body 15. The link member 52 may also facilitate movement of the door 12 and be considered part of the door 12.

Referring to FIGS. 1-4, operation of the assembly 10 will now be described in detail. When the door 12 is in the first position shown in FIG. 1, the conductor 20 is in the retracted position shown in FIG. 3. As the door 12 is moved from the first position to the second position, shown in phantom lines in FIG. 2, the link member 52 pivots with respect to the vehicle body 15 and the carrier 18, and causes the carrier 18 to move longitudinally along the guide member 16 from the first carrier position, shown in FIG. 3, to the second carrier position, shown in FIG. 4. As a result, the carrier 18 pulls the conductor 20 from the retracted position, shown in FIG. 3, to the extended position, shown in FIG. 4. As the conductor 20 moves toward the extended position, the spacing between adjacent coils increases.

Referring to FIG. 8, a second embodiment 10′ of an electrical conductor assembly, such as a wire harness assembly, according to the invention is shown. The assembly 10′ is similar to the assembly 10, and functions in a similar manner. Moreover, similar components of the two embodiments are identified with similar reference numbers.

The assembly 10′ shown in FIG. 8, however, includes multiple extendable conductors 20′ that are each moveable between a retracted position and an extended position. For example, a portion of each conductor 20′ may have a coiled configuration that enables the conductor 20′ to be extended. Each conductor 20′ may also include one or more wires or other electrical conductors that are insulated from each other.

Furthermore, each conductor 20′ may have an electrical connector disposed at each end for connecting the assembly 10′ to other electrical components, such as described above in detail. As another example, the conductors 20′ may share a common electrical connector at each end. As shown in FIG. 8, for example, uncoiled portions of the conductors 20′ feed through carrier 18′ and link member 52′, and are connected to a single electrical connector 42′.

As shown in FIG. 8, guide member 16′ of assembly 10′ may be configured to space the conductors 20′ apart so that the conductors 20′ so that the conductors 20′ do not rub against each other as they move between the retracted and extended positions. For example, the guide member 16′ may include a generally tubular body having a divider member, such as a rib 56, that defines multiple cavities 58 that each receive a conductor 20′.

Like the assembly 10, the assembly 10′ may also include a housing (not shown) for receiving a portion, such as a coiled portion, of each conductor 20′ when the conductors 20′ are in the retracted positions. Such a housing may also include a divider member, such as a rib, for spacing apart the conductors 20′.

By using one ore more extendable conductors, such as described above, the size and complexity of the electrical conductor assembly may be reduced compared to prior wire harness assemblies. Furthermore, by using multiple conductors that each include multiple wires or other electrical conductors, the number of electrical circuits serviced by the assembly may be significantly increased.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, a wire harness assembly according to the invention may be provided with a carrier that is configured as a sliding member that slides along any suitable guide member.

1. An electrical conductor assembly for use with a vehicle having a moveable part, the assembly comprising:
a guide member that is mountable on the moveable part;
a carrier that is moveable along the guide member between first and second carrier positions as the moveable part moves between first and second part positions; and
an extendable conductor associated with the carrier and being moveable between a retracted position and an extended position as the carrier moves between the first and second carrier positions, wherein at least a portion of the conductor has a coiled configuration.

2. The assembly of claim 1 wherein the guide member comprises a tubular member having a groove, and the carrier is moveable along the groove.

3. The assembly of claim 1 wherein the carrier comprises a roller mechanism having at least one roller that is engageable with the guide member.

4. The assembly of claim 3 wherein the guide member has a groove and the at least one roller of the roller mechanism is moveable along the groove, and wherein the roller mechanism further comprises first and second flange members disposed on opposite sides of the at least one roller, such that flange members extend on opposite sides of the groove, each flange member having an aperture that receives the conductor.

5. The assembly of claim 4 further comprising a link member pivotally connected to the roller mechanism, the link member further being configured to be connected to a vehicle body of the vehicle such that the link member is pivotable with respect to the vehicle body.

6. (canceled)

7. The assembly of claim 1 wherein the conductor comprises a coiled cable.

8. The assembly of claim 1 further comprising an additional extendable conductor associated with the carrier and being moveable between a retracted position and an extended position as the carrier moves between the first and second carrier positions.

9. The assembly of claim 8 wherein the conductors extend into the guide member when the conductors are in the extended positions, and wherein the guide member includes a divider member for spacing the conductors away from each other.

10. The assembly of claim 8 wherein at least a portion of each conductor has a coiled configuration, and the portions are spaced away from each other.

11. A wire harness assembly for use with a vehicle having a moveable door connected to a vehicle body, the assembly comprising:
a tubular member that is mountable on the door, the tubular member having a longitudinal groove;
a roller mechanism that is moveable along the groove of the tubular member, the roller mechanism being moveable between first and second positions as the door moves between first and second door positions;
an extendable conductor associated with the roller mechanism and being moveable between a retracted position and an extended position as the roller mechanism moves between the first and second positions, at least a portion of the conductor having a coiled configuration; and
a link member pivotally connected to the roller mechanism and configured to be connected to the vehicle body such that the link member is pivotable with respect to the vehicle body, the link member being configured to facilitate movement of the roller mechanism as the door moves between the first and second door positions.

12. The assembly of claim 11 further comprising an additional extendable conductor associated with the roller mechanism and being moveable between a retracted position and an extended position as the roller mechanism moves between the first and second positions, at least a portion of the additional conductor having a coiled configuration that is spaced away from the portion of the conductor having the coiled configuration.

13. The assembly of claim 12 wherein the conductors extend into the tubular member when the conductors are in the extended positions, and wherein the tubular member includes a divider member for spacing the conductors away from each other.

14. The assembly of claim 12 wherein the conductors are connected to a common electrical connector.

15. An electrical conductor assembly for use with a vehicle having a moveable part, the assembly comprising:
a guide member that is mountable on the moveable part;
a carrier that is moveable along the guide member between first and second carrier positions as the moveable part moves between first and second part positions; and
an extendable conductor associated with the carrier and being moveable between a retracted position and an extended position as the carrier moves between the first and second carrier positions, wherein spacing between adjacent portions of the conductor increases as the conductor moves from the retracted position toward the extended position.

16. The assembly of claim 15 wherein at least a portion of the conductor has a coiled configuration.

17. The assembly of claim 15 wherein the conductor comprises a coiled cable.

18. The assembly of claim 15 wherein the guide member has a groove and the carrier comprises a roller mechanism having at least one roller that is moveable along the groove, and wherein the roller mechanism further comprises first and second flange members disposed on opposite sides of the at least one roller, such that flange members extend on opposite sides of the groove.

19. The assembly of claim 18 wherein each flange member has an aperture that receives the conductor.
